(19) United States
(12) Patent Application Publication
(10) Pub. No.: US 2025/0252041 A1
(43) Pub. Date: Aug. 7, 2025

(54) DATA PROCESSING METHOD AND APPARATUS BASED ON MEMORY ACCESS ENGINE, DEVICE, MEMORY ACCESS ENGINE, COMPUTER PROGRAM PRODUCT

(71) Applicant: TENCENT TECHNOLOGY (SHENZHEN) COMPANY LIMITED, Shenzhen (CN)

(72) Inventor: Zimu REN, Shenzhen (CN)

(21) Appl. No.: 19/190,971

(22) Filed: Apr. 28, 2025

Related U.S. Application Data
(63) Continuation of application No. PCT/CN2023/134062, filed on Nov. 24, 2023.

(30) Foreign Application Priority Data
Mar. 29, 2023 (CN) 202310358826.4

(51) Int. Cl. G06F 12/02

(52) U.S. Cl. CPC G06F 12/023

(57) ABSTRACT

A data processing method including obtaining migration-candidate data using N data reading components, transmitting the migration-candidate data to a scheduler, determining a target storage type and transmitting, using the scheduler, target migration-candidate data to a target core processing component, and processing the target migration-candidate data using the target core processing component to obtain processed data to be converted in the memory access engine into target migration data. The target migration-candidate data is at least a portion of the migration-candidate data that has the target storage type, the target storage type is a storage type with a highest priority determined by the scheduler through round-robin scheduling, and the target core processing component is one of S core processing components that is in an idle state. N and S are positive integers greater than 1, and S is less than N.

### CROSS-REFERENCE TO RELATED APPLICATIONS

This application is a continuation of International Application No. PCT/CN2023/134062, filed on Nov. 24, 2023, which is based upon and claims priority to Chinese Patent Application No. 202310358826.4, filed on Mar. 29, 2023, which are incorporated herein by reference in their entirety.

### FIELD OF THE TECHNOLOGY

This application relates to the field of computer technologies, and in particular, to a data processing method and apparatus based on a memory access engine, a device, a memory access engine, and a computer program product.

### BACKGROUND OF THE DISCLOSURE

Data migration efficiency of a direct memory access (DMA) engine directly affects performance of a central processing unit (CPU). In current DMA, independent data paths are instantiated for different data storage formats, each path processes data of a corresponding data storage type, and a component for performing core resource processing needs to be created in each path. Even if the utilization rate of core resource processing is not high, as long as there is any demand for core resource processing, the component needs to be instantiated in each data path. Therefore, repeatedly created components for performing core resource processing consume a large amount of area on a DMA chip.

### SUMMARY

In accordance with the disclosure, there is provided a data processing method including obtaining migration-candidate data using N data reading components of a memory access engine, transmitting the migration-candidate data to a scheduler of the memory access engine, determining a target storage type and transmitting, using the scheduler, target migration-candidate data to a target core processing component, and processing the target migration-candidate data using the target core processing component to obtain processed data to be converted in the memory access engine into target migration data capable of being migrated to a memory. The target migration-candidate data is at least a portion of the migration-candidate data that has the target storage type, the target storage type is a storage type with a highest priority determined by the scheduler through round-robin scheduling, and the target core processing component is one of S core processing components, that is in an idle state, of the memory access engine. N is a positive integer greater than 1, and S is a positive integer greater than 1 but less than N.

Also in accordance with the disclosure, there is provided a memory access engine including N data reading components, a scheduler connected to the N data reading components, and S core processing components connected to the scheduler. N and S are positive integers greater than 1, and S is less than N. The N data reading components are configured to obtain migration-candidate data, and transmit the migration-candidate data to the scheduler. The scheduler is configured to determine a storage type with a highest priority that is obtained through round-robin scheduling as a target storage type, and transmit target migration-candidate data to a target core processing component. The target migration-candidate data is at least a portion of the migration-candidate data that has the target storage type, and the target core processing component is one of the S core processing components that is in an idle state. The target core processing component is configured to process the target migration-candidate data to obtain processed data to be converted in the memory access engine into target migration data capable of being migrated to a memory.

Also in accordance with the disclosure, there is provided a computer device including a memory storing a computer program, a network interface, and a memory access engine connected to the memory and the network interface, and configured to invoke the computer program to cause the computer device to obtain migration-candidate data using N data reading components of the memory access engine, transmit the migration-candidate data to a scheduler of the memory access engine, determine a target storage type and transmit, using the scheduler, target migration-candidate data to a target core processing component, and process the target migration-candidate data using the target core processing component, to obtain processed data to be converted in the memory access engine into target migration data capable of being migrated to a memory. The target migration-candidate data is at least a portion of the migration-candidate data that has the target storage type, the target storage type is a storage type with a highest priority determined by the scheduler through round-robin scheduling, and the target core processing component is one of S core processing components, that is in an idle state, of the memory access engine. N is a positive integer greater than 1, and S is a positive integer greater than 1 but less than N.

### BRIEF DESCRIPTION OF THE DRAWINGS

To describe technical solutions in the embodiments of this application more clearly, the following briefly introduces the accompanying drawings used in the descriptions of the embodiments. Apparently, the accompanying drawings in the following description show only some embodiments of this application, and those of ordinary skill in the art may still derive other drawings from these accompanying drawings without creative efforts.

FIG. 1 is a schematic diagram of a system architecture of a terminal device according to an embodiment of this application.

FIG. 2 is a schematic structural diagram of a memory access engine according to an embodiment of this application.

FIG. 3 is a schematic flowchart of a data processing method according to an embodiment of this application.

FIG. 4 is another schematic structural diagram of a memory access engine according to an embodiment of this application.

FIG. 5 is another schematic flowchart of a data processing method according to an embodiment of this application.

FIG. 6 is a schematic structural diagram of an online processing component according to an embodiment of this application.

FIG. 7 is a schematic diagram showing an interleaving scene according to an embodiment of this application.

FIG. 8 is a schematic diagram showing a deinterleaving scene according to an embodiment of this application.

FIG. 9 is a third schematic structural diagram of a memory access engine according to an embodiment of this application.

FIG. 10 is a schematic structural diagram of a data processing apparatus according to an embodiment of this application.

FIG. 11 is a schematic structural diagram of a computer device according to an embodiment of this application.

### DESCRIPTION OF EMBODIMENTS

The technical solutions in the embodiments of this application will be described below with reference to the accompanying drawings in the embodiments of this application. Apparently, the described embodiments are merely some rather than all of the embodiments of this application. All other embodiments obtained by those of ordinary skill in the art based on the embodiments in this application without involving any creative effort fall within the scope of protection of this application.

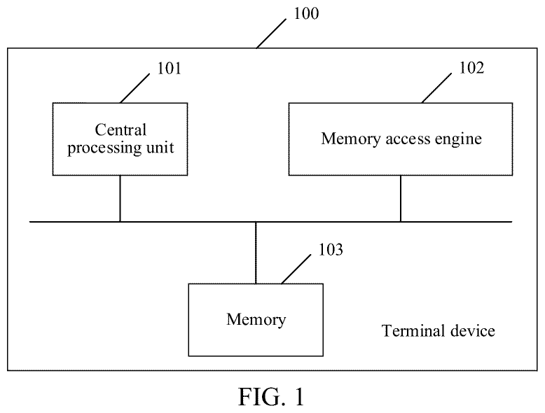

FIG. 1 is a schematic diagram of a system architecture of a terminal device according to an embodiment of this application. A system architecture of a terminal device 100 may include a central processing unit (CPU) 101, a memory access engine 102 (may also be referred to as a direct memory access (DMA) engine), and a memory 103. The terminal device 100 of this application may include a mobile terminal, a server, and the like, which is not limited herein.

The terminal device 100 may also have a communication connection to another terminal or server, and transmit to-be-migrated data (also referred to as “migration-candidate data”) or processed to-be-migrated data through the communication connection. The foregoing communication connection is not limited to a specific connection manner, may be a direct or indirect connection in a wired manner, or may be a direct or indirect connection in a wireless manner, or may be implemented in another manner, which is not limited herein. The terminal device 100 includes, but is not limited to, a mobile phone, a computer, an intelligent voice interaction device, a smart home appliance, an in-vehicle terminal, and the like.

The memory access engine 102 may include several data reading components, several core processing components, and a scheduler. Different data reading components may read data of different storage types. The core processing components are components configured to process core services. The core services may be preset services that have a complex processing process and high importance, and consume many resources, and may include, for example, a transposition service and a padding service.

In some embodiments, the memory access engine 102 obtains to-be-migrated data by using the data reading components according to a task request of the CPU 101. The to-be-migrated data may come from the memory 103. A storage type of the memory 103 may be classified into a local type or an outer type.

The data reading component may refer to a read interface that is in the memory access engine 102 and that is configured to call the memory 103.

The memory access engine 102 may transmit the to-be-migrated data to the scheduler by using the data reading components. The scheduler may determine a priority identifier of the data reading component according to a storage type corresponding to the data reading component, and determine to-be-migrated data to be preferentially processed according to the priority identifier of the data reading component to which the to-be-migrated data belongs.

The scheduler may determine a storage type mapped to a priority identifier registered in the scheduler as a storage type with a highest priority, assign to-be-migrated data associated with the storage type with the highest priority to a core processing component in an idle state, and perform processing by using the core processing component, to obtain processed data.

The scheduler may perform polling update on the priority identifier, determine a next storage type after previous scheduling (assignment) as the storage type with the highest priority, to implement polling on the data reading components of different storage types, whereby the different data reading components may use the core processing components by turns to perform core service processing on the to-be-migrated data.

The memory access engine 102 may continue to perform another processing (such as bias adding or interleaving) on the processed data, to obtain target migration data. The memory access engine 102 may migrate the target migration data to the memories 103 of different storage types by using write interfaces (data writing components) corresponding to the memories 103 of different storage types.

The memory access engine 102 may determine the priority identifier of the storage type, perform round-robin scheduling on the storage types of different data reading components to obtain the storage type with the highest priority, and determine the to-be-migrated data on which core service processing is preferentially performed by the core processing component in the idle state. Round-robin scheduling may be performed on S core processing components integrated in the memory access engine (the DMA engine) by using the scheduler. Therefore, a core processing component does not need to be instantiated in each data path. In this way, core resources (the core processing components) between a plurality of data paths are multiplexed, and an area-efficiency ratio (an effective area proportion) of the memory access engine 102 is improved.

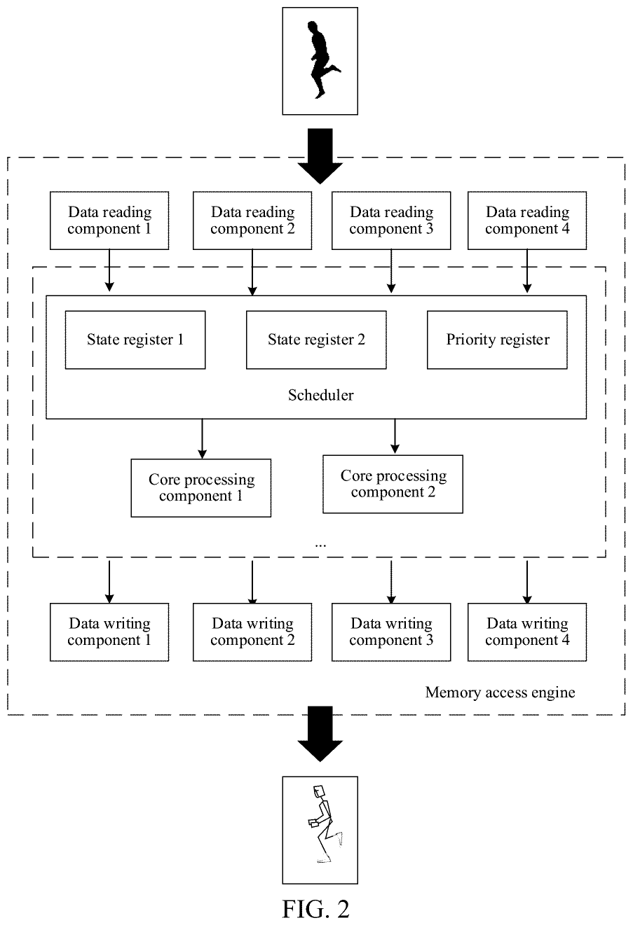

FIG. 2 is a schematic structural diagram of a memory access engine according to an embodiment of this application. In FIG. 2, a terminal device may migrate data, and may further perform core service processing during data migration. The core service processing may include transposition, padding, and the like. For example, a CPU of the terminal device may assign a task request (which may include a core service processing requirement and processing configuration information that may determine processing that needs to be performed on data (to-be-migrated data) in the task request by the memory access engine) to the memory access engine. The task request may include:

1. transposing to-be-migrated data A read by a data reading component 1 and migrating the processed to-be-migrated data A to a data writing component 2; and

2. padding to-be-migrated data B read by a data reading component 2 and migrating the processed to-be-migrated data B to a data writing component 1.

The memory access engine may transmit the to-be-migrated data A and the to-be-migrated data B to a scheduler.

A state register in the scheduler may determine a component state of a core processing component, that is, may update the component state in the state register mapped to the core processing component to a busy state when the core processing component starts data processing on target to-be-migrated data; and re-update the component state in the state register mapped to the core processing component to an idle state when the core processing component completes the data processing on the target to-be-migrated data.

For example, a state register 1 may determine that a core processing component 1 is in the idle state, and a state register 2 may determine that a core processing component 2 is in the busy state. The memory access engine may determine a state register in which a component state is the idle state as a target state register, and determine a core processing component mapped to the target state register as a target core processing component, that is, determine the state register 1 as the target state register, and determine the core processing component 1 as the target core processing component.

The scheduler may determine a priority identifier of a data reading component in advance according to a storage type of the data reading component. A priority identifier of the data reading component 1 may be 1, a priority identifier of the data reading component 2 may be 2, a priority identifier of a data reading component 3 may be 3, and a priority identifier of a data reading component 4 may be 4.

A priority register in the scheduler may register the priority identifier. The scheduler may determine a storage type mapped to the priority identifier registered in the scheduler as a storage type with a highest priority, determine to-be-migrated data corresponding to the storage type with the highest priority as the target to-be-migrated data, assign the target to-be-migrated data to the target core processing component (the core processing component 1, namely, the core processing component in the idle state), and the target core processing component processes the target to-be-migrated data, to obtain processed data.

For example, the order of performing polling update on the priority identifier in the scheduler cycles from 4 to 1. After completing scheduling once, the scheduler may increase the priority identifier registered in the scheduler by one. For example, after completing scheduling for the priority identifier of 1, the scheduler updates a priority identifier for next scheduling to 2, . . . , and after completing scheduling for the priority identifier of 4, the scheduler updates a priority identifier for next scheduling to 1.

The scheduler indicates that only the core processing component 1 is in the idle state, and the scheduler may determine the core processing component 1 as the target core processing component.

If the priority identifier registered in the scheduler at this time is 4, and there is no to-be-migrated data that needs to be processed in the data reading component 4, the priority register may continue to increase the priority identifier by one, that is, determine the priority identifier to be 1. A storage type of the data reading component 1 may be determined as a target storage type, the to-be-migrated data A in the data reading component 1 is assigned to the core processing component 1, the core processing component 1 transposes the to-be-migrated data A, and transmits the processed to-be-migrated data A to the data writing component 2 (a storage type of the data writing component 2 is different from the storage type of the data reading component 1).

The priority identifier registered in the priority register is further increased by one, that is, the priority identifier is determined to be 2. If the core processing component 1 is in the idle state after completing the processing, and the scheduler indicates that only the core processing component 1 is in the idle state (that is, only the core processing component 1 is the target core processing component), the scheduler may assign the to-be-migrated data B in the data reading component 2 to the core processing component 1, and the core processing component 1 pads the to-be-migrated data B, and transmits the processed to-be-migrated data B to the data writing component 1 (a storage type of the data writing component 1 is different from a storage type of the data reading component 2).

The data writing component may alternatively refer to the writing interface that is in the memory access engine in the embodiment corresponding to FIG. 1 and that is configured to call the memory 103. The memory access engine can implement data migration between memories of different storage types by using read and write interfaces corresponding to the memories of different storage types, namely, the data reading components and the data writing components.

According to the embodiments of this application, the to-be-migrated data is obtained by using N data reading components, and the to-be-migrated data is transmitted to the scheduler. The scheduler has the function of performing round-robin scheduling on the priority of the storage type. The storage type with the highest priority that is obtained by the scheduler through round-robin scheduling is determined as the target storage type, and the target to-be-migrated data of the target storage type is transmitted by using the scheduler to the target core processing component in the idle state of S core processing components. Core service processing is performed on the target to-be-migrated data by using the target core processing component, to obtain processed data. The processed data is converted, in the memory access engine, into target migration data capable of being migrated to a memory. It can be seen that round-robin scheduling may be performed on the S core processing components integrated in the memory access engine (a DMA engine) by using the scheduler. Therefore, a core processing component does not need to be instantiated in each data path. In this way, core resources (the core processing components) between a plurality of data paths are multiplexed, and an effective area proportion of the memory access engine is improved.

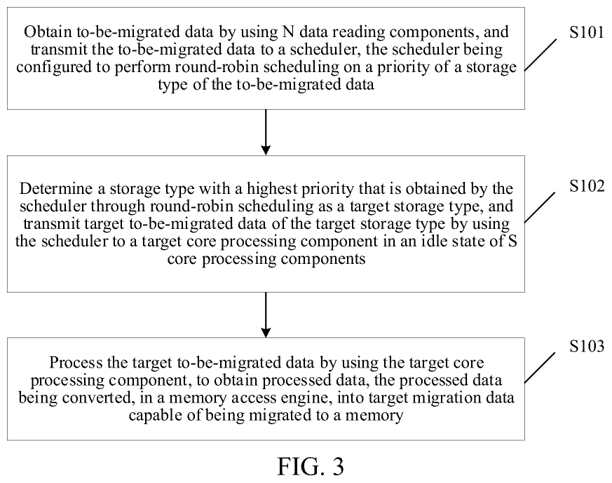

FIG. 3 is a schematic flowchart of a data processing method according to an embodiment of this application. The data processing method may be performed by a memory access engine, and the memory access engine may be the memory access engine 102 of the terminal device 100 shown in FIG. 1. As shown in FIG. 3, the method includes the following operations:

Operation S101: Obtain to-be-migrated data by using N data reading components, and transmit the to-be-migrated data to a scheduler, the scheduler being configured to perform round-robin scheduling on a priority of a storage type of the to-be-migrated data.

In some embodiments, the memory access engine (which may also be referred to as a DMA engine) may include the N data reading components, one scheduler, S core processing components, and N data writing components. Both N and S are positive integers, and S is less than N.

The memory access engine may obtain the to-be-migrated data by using several data reading components. Different data reading components may read to-be-migrated data of different storage types. The storage types may be classified into a local type and an outer type.

The data reading components and the data writing components may be respectively read and write interfaces that are in the memory access engine and that are configured to call a local memory and an outer memory. The local memory and the outer memory may be specifically a level 2 cache (L2 cache), a double data rate random-access memory (DDR RAM), or a level 1 cache (L1 cache). The L1 cache may include an L1a cache and an L1b cache.

The memory access engine may transmit the to-be-migrated data to the scheduler.

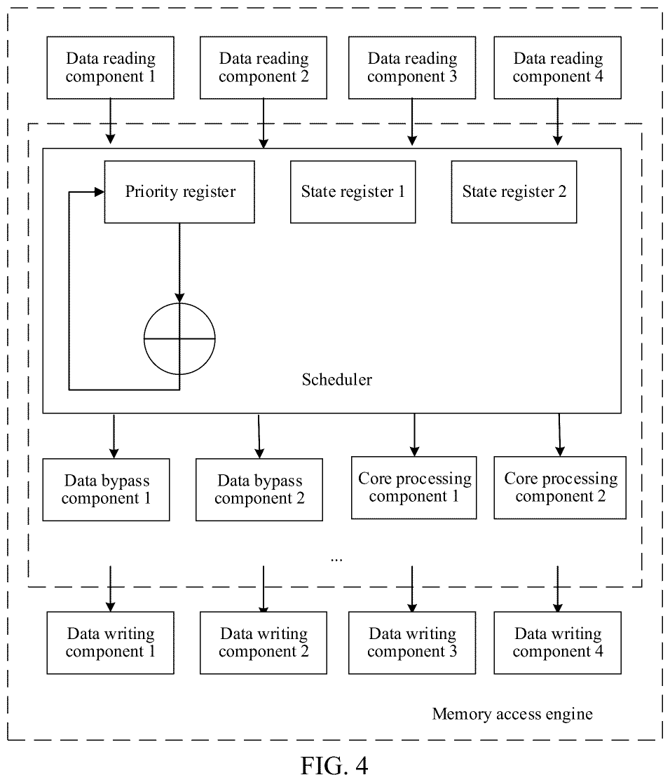

FIG. 4 is another schematic structural diagram of a memory access engine according to an embodiment of this application. A memory access engine includes 4 data reading components and 4 data writing components, 1 scheduler, and 2 core processing components, and the scheduler includes 2 state register and 1 priority register.

As shown in FIG. 4, a storage type of a data reading component 1 may correspond to an L2 cache, a storage type of a data reading component 2 may correspond to a DDR RAM, a storage type of a data reading component 3 may correspond to an L1a cache, and a storage type of a data reading component 4 may correspond to an L1b cache. For example, the memory access engine may read to-be-migrated data of the storage type corresponding to the L2 cache by using the data reading component 1.

Operation S102: Determine a storage type with a highest priority that is obtained by the scheduler through round-robin scheduling as a target storage type, and transmit target to-be-migrated data of the target storage type by using the scheduler to a target core processing component in an idle state of S core processing components.

In some embodiments, the scheduler of the memory access engine may include a state register and a priority register. A quantity of the state registers is the same as that of the core processing components. That is, one state register corresponds to one core processing component. The state register is configured to store a component state of the corresponding core processing component. The component state of the core processing component may be the idle state or a busy state. The memory access engine may determine the component state of the core processing component by using the state register, determine to-be-migrated data to be preferentially processed according to a priority identifier of the data reading component where the to-be-migrated data is located, assign the target to-be-migrated data with the highest priority to the core processing component in the idle state, and process the target to-be-migrated data with the highest priority by using the core processing component in the idle state.

For example, a CPU may assign a task request (which may also be referred to as a core service processing requirement, and processing that needs to be performed on the target to-be-migrated data in the memory access engine may be determined according to the core service processing requirement) to the memory access engine for preprocessing. The task request may include:

1. transposing to-be-migrated data A in the data reading component 1 and migrating the processed to-be-migrated data A to a data writing component 2;

2. padding to-be-migrated data B in the data reading component 2 and migrating the processed to-be-migrated data B to a data writing component 3; and

3. migrating to-be-migrated data C in the data reading component 3 to a data writing component 4.

The core service processing may include transposition and padding.

A process in which the scheduler determines the target to-be-migrated data based on the priority identifier may be: the scheduler obtains a priority identifier registered in the priority register, determines a storage type mapped to the priority identifier as the target storage type, and determines to-be-migrated data of the target storage type in a plurality of pieces of to-be-migrated data obtained by using the N data reading components as the target to-be-migrated data; determines a state register, in which a component state is the idle state, of the S state registers as a target state register, and determines a core processing component mapped to the target state register as the target core processing component; and transmits the target to-be-migrated data to the target core processing component, and performs polling update on the priority identifier in the priority register. The priority identifier subjected to polling update is configured to represent that a next storage type after polling is the storage type with the highest priority. In this way, polling of the data reading components of different storage types can be implemented, and the different data reading components may use the core processing components by turns to perform core service processing on the to-be-migrated data.

The state register in the scheduler may determine the component state of the core processing component, that is, may update the component state in the state register mapped to the core processing component to the busy state when the core processing component starts core service processing on the target to-be-migrated data, and re-update the component state in the state register mapped to the core processing component to the idle state when the core processing component completes the core service processing on the target to-be-migrated data. In this way, the component state in the state register can be consistent with an actual state of the core processing component, which can ensure that an available core processing component is scheduled.

In FIG. 4, a state register 1 may indicate that a core processing component 1 is in the idle state based on recorded control information busy 1=false, and a state register 2 may indicate that a core processing component 2 is in the busy state based on recorded control signal busy2=true. Therefore, the memory access engine may determine the state register 1 as the target state register.

For example, in the state register 1, busy 1=false indicates that the core processing component 1 is in the idle state, and busy 1=true indicates that the core processing component 1 is in the busy state. In the state register 2, busy2=false indicates that the core processing component 2 is in the idle state, and busy2=true indicates that the core processing component 2 is in the busy state.

The scheduler may determine the priority identifier of the data reading component in advance according to the storage type of the data reading component. For example, the scheduler may determine a priority identifier of the data reading component 1 of the storage type corresponding to the L2 cache to be 1, determine a priority identifier of the data reading component 2 of the storage type corresponding to the DDR RAM to be 2, determine a priority identifier of the data reading component 3 of the storage type corresponding to the L1a cache to be 3, and determine a priority identifier of the data reading component 4 of the storage type corresponding to the L1b cache to be 4.

To-be-migrated data of a same storage type may have a same priority identifier. The priority identifier of the data reading component may be preset, or the priority identifier may be assigned to the data reading component based on information carried in a task request when the CPU assigns the task request.

The priority register in the scheduler may register the priority identifier. The scheduler may determine a storage type mapped to the registered priority identifier as the storage type with the highest priority, and assign to-be-migrated data associated with the storage type with the highest priority to the core processing component in the idle state, and the core processing component performs core service processing, to obtain processed data.

For example, the order of performing polling update on the priority identifier in the scheduler cycles from 4 to 1. After completing scheduling once, the scheduler may increase the priority identifier registered in the scheduler by one. For example, after completing scheduling for the priority identifier of 1, the scheduler updates a priority identifier for next scheduling to 2, . . . , and after completing scheduling for the priority identifier of 4, the scheduler updates a priority identifier for next scheduling to 1.

The memory access engine may determine the storage type corresponding to the priority identifier registered in the priority register as the target storage type, and assign the target to-be-migrated data of the target storage type to the target core processing component (the core processing component in the idle state) for core service processing.

Operation S103: Process the target to-be-migrated data by using the target core processing component, to obtain processed data, the processed data being converted, in the memory access engine, into target migration data capable of being migrated to a memory.

In some embodiments, the memory access engine may determine the storage type mapped to the priority identifier registered in the priority register as the storage type with the highest priority, and assign the target to-be-migrated data with the highest priority to the core processing component in the idle state for core service processing, to obtain processed data.

In FIG. 4, the state register 1 indicates that the core processing component 1 is in the idle state, and the state register 2 indicates that the core processing component 2 is in the busy state. Therefore, the scheduler indicates that only the core processing component 1 is in the idle state, and the scheduler may determine the core processing component 1 as the target core processing component.

The memory access engine may detect a core service processing requirement in a task request corresponding to the target to-be-migrated data, and perform the operation of transmitting target to-be-migrated data by using the scheduler to a target core processing component of S core processing components if the target to-be-migrated data requires core service processing; and transmit the target to-be-migrated data by using the scheduler to a data bypass component if the target to-be-migrated data does not require core service processing, and determine target to-be-migrated data outputted by the data bypass component as the processed data. In this way, not only the target to-be-migrated data can be assigned to a proper component based on different actual service processing requirements, but also the core service processing component can be prevented from processing data that does not need to be subjected to core service processing, which can effectively improve the utilization rate of the core service processing component.

If there is no core service processing requirement in the task request for the to-be-migrated data, for example, the to-be-migrated data C does not need to be subjected to core service processing, the scheduler may perform bypass processing on the to-be-migrated data C by using the data bypass component (which may be a data bypass component 1 or a data bypass component 2). The bypass processing means that no other processing is performed. The to-be-migrated data C is determined as the processed data and transmitted to the data writing component 4.

If there is a core service processing requirement in a task request for the to-be-migrated data A (it is assumed that the to-be-migrated data A is determined as the target to-be-migrated data) in the data reading component 1, the memory access engine may assign the to-be-migrated data A to the core processing component 1, transpose the to-be-migrated data A, and transmit the processed to-be-migrated data A to the data writing component 2.

The priority identifier registered in the priority register is further increased by one, that is, the priority identifier is determined to be 2. If the core processing component 1 is in the idle state after completing the processing, and only the core processing component 1 corresponds to the idle state in the scheduler (that is, only the core processing component 1 is the target core processing component), the scheduler may assign the to-be-migrated data B in the data reading component 2 to the core processing component 1, pad the to-be-migrated data B, and transmit the processed to-be-migrated data B to the data writing component 3.

The memory access engine may implement data migration between memories of different storage types by using read and write interfaces configured to call the memories of different storage types, namely, the data reading components and the data writing components.

The to-be-migrated data A and the to-be-migrated data B that are subjected to corresponding processing may be the processed data.

It can be seen that in the embodiments of this application, the target migration data may be identical to the processed data. That is, after obtaining the processed data, the memory access engine may directly transmit the processed data to a corresponding data writing component, to complete migration of data of different storage types. Alternatively, the processed data may be converted into the target migration data through another processing in the memory access engine. The another processing may be scene processing (including rectified linear unit (ReLU) activation function, quantization, bias adding, and the like), interleaving, deinterleaving, or the like.

According to the embodiments of this application, the to-be-migrated data is obtained by using the N data reading components, and the to-be-migrated data is transmitted to the scheduler. The scheduler has the function of performing round-robin scheduling on the priority of the storage type. The storage type with the highest priority that is obtained by the scheduler through round-robin scheduling is determined as the target storage type, and the target to-be-migrated data of the target storage type is transmitted by using the scheduler to the target core processing component of the S core processing components. The target core processing component is the core processing component in the idle state. Core service processing is performed on the target to-be-migrated data by using the target core processing component, to obtain processed data. The processed data is converted, in the memory access engine, into the target migration data capable of being migrated to the memory. It can be seen that round-robin scheduling may be performed on the S core processing components integrated in the memory access engine (the DMA engine) by using the scheduler. Therefore, a core processing component does not need to be instantiated in each data path. In this way, core resources (the core processing components) between a plurality of data paths are multiplexed, and an effective area proportion of the memory access engine is improved.

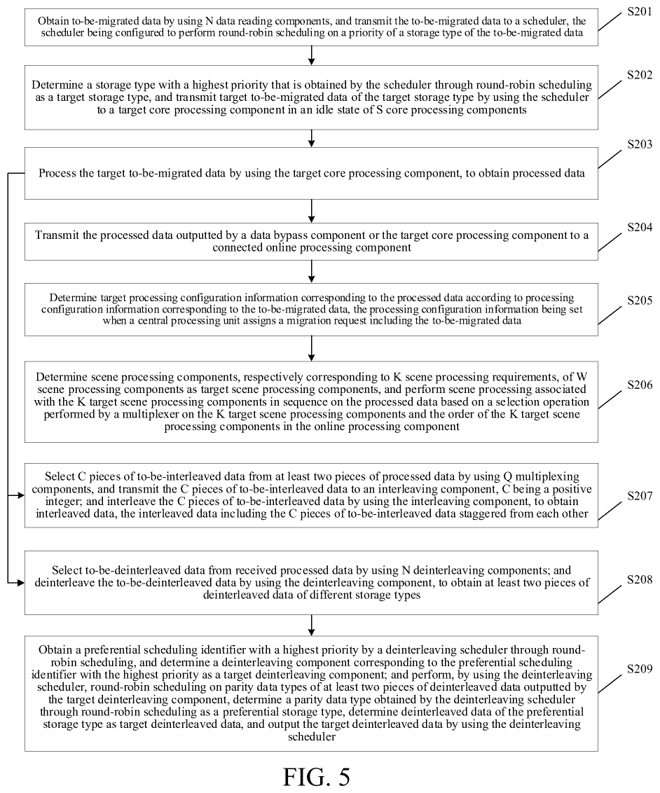

FIG. 5 is another schematic flowchart of a data processing method according to an embodiment of this application. The data processing method may be performed by a memory access engine, and the memory access engine may be the memory access engine 102 of the terminal device 100 shown in FIG. 1. As shown in FIG. 5, the method includes the following operations:

Operation S201: Obtain to-be-migrated data by using N data reading components, and transmit the to-be-migrated data to a scheduler, the scheduler being configured to perform round-robin scheduling on a priority of a storage type of the to-be-migrated data.

In some embodiments, refer to the foregoing specific description of operation S101 in the embodiment corresponding to FIG. 3.

Operation S202: Determine a storage type with a highest priority that is obtained by the scheduler through round-robin scheduling as a target storage type, and transmit target to-be-migrated data of the target storage type by using the scheduler to a target core processing component in an idle state of S core processing components.

In some embodiments, refer to the foregoing description of operation S102 in the embodiment corresponding to FIG. 3.

Operation S203: Process the target to-be-migrated data by using the target core processing component, to obtain processed data.

In some embodiments, refer to the foregoing description of operation S103 in the embodiment corresponding to FIG. 3.

Operation S204: Transmit the processed data outputted by a data bypass component or the target core processing component to a connected online processing component.

In some embodiments, the memory access engine may further include N online processing components, and the online processing component may include W scene processing components. Both N and W are positive integers.

The memory access engine may transmit the processed data outputted by the data bypass component or the core processing component (which may be the target core processing component) to the connected online processing component. The data bypass component may perform bypass processing. The bypass processing means that no other processing is performed. The data bypass component and the core processing component may be integrated into one component, that is, the integrated core processing component may also perform the bypass processing.

Operation S205: Determine target processing configuration information corresponding to the processed data according to processing configuration information corresponding to the to-be-migrated data, the processing configuration information being set when a CPU assigns a migration request including the to-be-migrated data; and the target processing configuration information including K scene processing requirements, and K being a positive integer less than or equal to W.

In some embodiments, the memory access engine may detect processing configuration information in a task request for the to-be-migrated data, and determine, based on the processing configuration information, processing that needs to be performed on the processed data in the online processing component.

The task request may also be referred to as the migration request. The task request may include the processing configuration information. The processing configuration information may be set when the CPU assigns the migration request including the to-be-migrated data. The processing configuration information may include a scene processing requirement for the to-be-migrated data. The processing configuration information may determine scene processing that needs to be performed on the corresponding target to-be-migrated data in the scene processing component and the order of the scene processing.

Operation S206: Determine scene processing components, respectively corresponding to the K scene processing requirements, of the W scene processing components as target scene processing components, and perform scene processing associated with the K target scene processing components in sequence on the processed data based on a selection operation performed by a multiplexer on the K target scene processing components and the order of the K target scene processing components in the online processing component.

In some embodiments, the memory access engine may determine the scene processing that needs to be performed on the to-be-migrated data and the order of the processing according to the processing configuration information of the to-be-migrated data. The online processing component may include several scene processing components.

The scene processing component may perform scene processing such as ReLU, quantization, and bias adding. For example, ReLU refers to selection of a default activation function of a deep neural network for the processed data; quantization refers to quantization and conversion of the processed data into an input capable of being subsequently recognized by another component; and bias adding refers to addition of a bias to a key-value sequence of the processed data. The scene processing component may also perform bypass processing, and transmit processed data subjected to bypass processing to the multiplexer. “Bypass processing” means bypassing any actual processing, i.e., data being “subjected to bypass processing” means the data does not undergo any actual processing (hence any actual processing is “bypassed”), and hence output data of such “bypass processing” remains same as the input data of the “bypass processing.”

The online processing component further includes the multiplexer. The multiplexer may be connected to each scene processing component. That is, the multiplexer may determine which scene processing component needs to perform online processing on the processed data, which ensures that an accurate scene processing component is selected for the processed data.

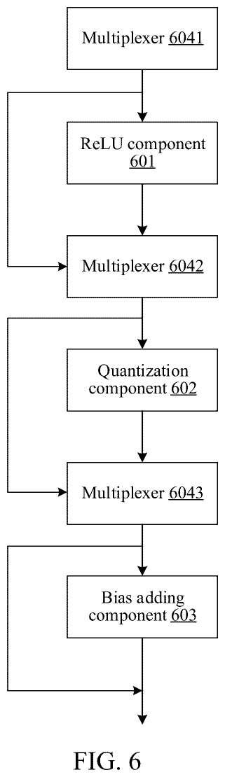

FIG. 6 is a schematic structural diagram of an online processing component according to an embodiment of this application.

The online processing component of the memory access engine may include an ReLU component 601, a quantization component 602, and a bias adding component 603. The ReLU component 601 is configured to perform ReLU on data, the quantization component 602 is configured to quantize data, and the bias adding component 603 is configured to add a bias to data.

For example, according to processing configuration information of processed data D, ReLU needs to be first performed on the processed data D and then add adding is performed.

A multiplexer 6041 may be in communication with the ReLU component, and transmit the processed data D (data transmitted to the online processing component) to the ReLU component. The ReLU component performs ReLU on the processed data D, to obtain data E, and transmits the data E to a multiplexer 6042.

The multiplexer 6042 may directly transmit the data E to a multiplexer 6043. The multiplexer 6043 may be in communication with the bias adding component, and transmit the data E to the bias adding component. The bias adding component adds a bias to the data E to obtain data F, and transmits the data F to another subsequent component.

The multiplexer 6041 may perform data transmission with the multiplexer 6042, and the multiplexer 6041 may perform data transmission with the multiplexer 6043.

Scene processing (namely, data processing such as quantization and bias adding) that needs to be performed in the online processing component is relatively simple. Therefore, the online processing components consume a relatively small chip area, and resources of the online processing components may not be multiplexed between data paths. In the embodiments of this application, one online processing component may be instantiated in each data path, to accelerate overall data processing efficiency.

In some embodiments, a scheduler is assigned to the online processing component, to implement polling of the online processing components, that is, implement multiplexing of the online processing components. For a processing method for multiplexing the online processing components by using the scheduler, refer to the specific description of operation S102 in the embodiment corresponding to FIG. 3.

The memory access engine may perform corresponding scene processing in sequence on the processed data by using the online processing component, to obtain target migration data capable of being migrated to a memory.

Operation S207: Select C pieces of to-be-interleaved data (also referred to as “interleaving-candidate data”) from at least two pieces of processed data by using Q multiplexing components, and transmit the C pieces of to-be-interleaved data to an interleaving component, C being a positive integer; and interleave the C pieces of to-be-interleaved data by using the interleaving component, to obtain interleaved data, the interleaved data including the C pieces of to-be-interleaved data staggered from each other; and the interleaved data being converted, in the memory access engine, into target migration data capable of being migrated to a memory.

In some embodiments, the memory access engine may select, by using the multiplexing component, processed data that needs to be interleaved in a task request as the to-be-interleaved data, and transmit the C pieces of to-be-interleaved data to the interleaving component for interleaving, to obtain the interleaved data. C is a positive integer.

In some embodiments, the to-be-interleaved data is data outputted by the online processing component, that is, the to-be-interleaved data is data subjected to scene processing or bypass processing in the online processing component.

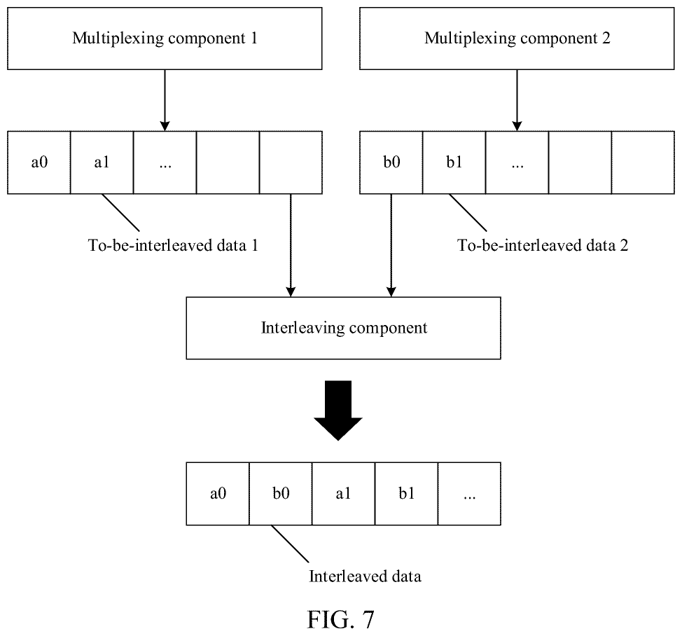

FIG. 7 is a schematic diagram showing an interleaving scene according to an embodiment of this application. As shown in FIG. 7, the interleaving refers to parity interleaving of two pieces of to-be-interleaved data (to-be-interleaved data 1 and to-be-interleaved data 2). That is, data units (a0, a1, . . . ) of the to-be-interleaved data 1 are placed on even bits (a data index is an even number, and a data unit with an index of 0 may also be determined as an even bit) of output data, data units (b0, b1, . . . ) of the to-be-interleaved data 2 are placed on odd bits (a data index is an odd number) of the output data, and the output data (a0, b0, al, b1, . . . ) is determined as the interleaved data.

The memory access engine may interleave the to-be-migrated data by using the interleaving component, to obtain the target migration data capable of being migrated to the memory.

Operation S208: Select to-be-deinterleaved data (also referred to as “deinterleaving-candidate data”) from received processed data by using N deinterleaving components; and deinterleave the to-be-deinterleaved data by using the deinterleaving component, to obtain at least two pieces of deinterleaved data of different storage types, content of both the at least two pieces of deinterleaved data belonging to the to-be-deinterleaved data.

In some embodiments, the memory access engine may select, by using the deinterleaving component, processed data that needs to be deinterleaved in a task request as the to-be-deinterleaved data, and transmit the to-be-deinterleaved data to the deinterleaving component for deinterleaving, to obtain two pieces of deinterleaved data.

In some embodiments, the to-be-deinterleaved data is data outputted by the online processing component, that is, the to-be-deinterleaved data is data subjected to scene processing or bypass processing in the online processing component.

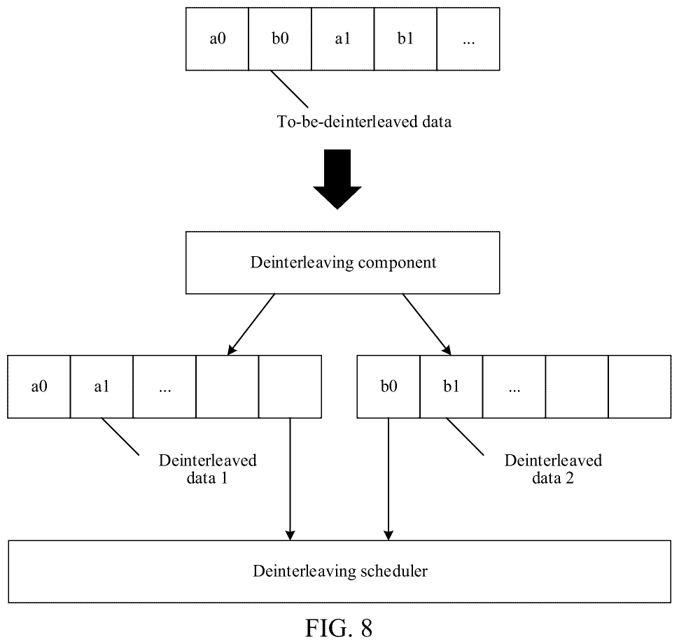

FIG. 8 is a schematic diagram showing a deinterleaving scene according to an embodiment of this application. As shown in FIG. 8, the deinterleaving refers to a reverse processing of interleaving. That is, parity deinterleaving is performed on to-be-deinterleaved data 1 (a0, b0, al, bl, . . . ), data units (a0, al, . . . ) on even bits of the to-be-deinterleaved data 1 are outputted as deinterleaved data 1, data units (b0, b1, . . . ) on odd bits of the to-be-deinterleaved data 1 are outputted as deinterleaved data 2, and the deinterleaved data 1 and the deinterleaved data 2 are obtained.

The deinterleaved data 1, the deinterleaved data 2, and deinterleaved data 3 may all be target deinterleaved data. The memory access engine may deinterleave the to-be-migrated data by using the deinterleaving component, to obtain the target migration data capable of being migrated to the memory.

Operation S209: Obtain a preferential scheduling identifier with a highest priority through round-robin scheduling performed by a deinterleaving scheduler, and determine a deinterleaving component corresponding to the preferential scheduling identifier with the highest priority as a target deinterleaving component; and perform, by using the deinterleaving scheduler, round-robin scheduling on parity data types of at least two pieces of deinterleaved data outputted by the target deinterleaving component, determine a parity data type obtained by the deinterleaving scheduler through round-robin scheduling as a preferential storage type, determine deinterleaved data of the preferential storage type as target deinterleaved data, and output the target deinterleaved data by using the deinterleaving scheduler, the target deinterleaved data being converted, in the memory access engine, into the target migration data capable of being migrated to the memory.

In some embodiments, each deinterleaving component outputs two pieces of deinterleaved data, and parity data types of the two pieces of deinterleaved data are different, which are respectively an odd data type and an even data type. The memory access engine may select, by using the deinterleaving scheduler connected after the deinterleaving component, data that needs to be deinterleaved in a task request.

When a plurality of deinterleaving components all have outputs, the deinterleaving scheduler may obtain the preferential scheduling identifier with the highest priority through round-robin scheduling, determine the deinterleaving component corresponding to the preferential scheduling identifier with the highest priority as the target deinterleaving component, and schedule two pieces of deinterleaved data outputted by the target deinterleaving component.

When all the outputs of the deinterleaving components need to be transmitted to a same data writing component, the deinterleaving scheduler may determine the parity data type obtained through round-robin scheduling as the preferential storage type, determine the deinterleaved data of the preferential storage type as the target deinterleaved data, and output the target deinterleaved data.

The deinterleaving scheduler may include a preferential scheduling register and a preferential storage register. The preferential scheduling register may register the preferential scheduling identifier of the deinterleaving component, and the preferential storage register may register the preferential storage type of the parity data type.

The deinterleaving scheduler may determine the preferential scheduling identifier of the deinterleaving component in advance. For example, the deinterleaving scheduler determines a preferential scheduling identifier of a deinterleaving component 1 to be 1, determines a preferential scheduling identifier of a deinterleaving component 2 to be 2, determines a preferential scheduling identifier of a deinterleaving component 3 to be 3, and determines a preferential scheduling identifier of a deinterleaving component 4 to be 4.

The deinterleaving scheduler may perform polling update on the order of preferential scheduling, which may cycle from 4 to 1. After the deinterleaving scheduler completes scheduling once, the preferential scheduling register may increase the preferential scheduling identifier registered in the preferential scheduling register by one. For example, after the deinterleaving component 1 is scheduled, a preferential scheduling identifier for next scheduling is updated to 2, . . . , and after the deinterleaving component 4 is scheduled, a preferential scheduling identifier for next scheduling is updated to 1.

After determining the target deinterleaving component, the deinterleaving scheduler may determine the deinterleaved data of the preferential storage type as the target deinterleaved data.

The deinterleaving scheduler may perform polling update on the order of the preferential storage type. The preferential storage type may cycle between the odd data type and the even data type. After the deinterleaving scheduler completes scheduling once, the preferential storage register may convert the preferential storage type registered in the preferential storage register once. For example, after the preferential storage type that is the odd data type is scheduled, the preferential storage register may update a preferential storage type for next scheduling to the even data type, and after the preferential storage type that is the even data type is scheduled, the preferential storage register may update a preferential storage type for next scheduling to the odd data type.

For example, the deinterleaving component 1 completes deinterleaving to obtain deinterleaved data 1 (of the odd data type) and deinterleaved data 2 (of the even data type), the deinterleaved data 1 needs to be transmitted to a data writing component 1, and the deinterleaved data 2 needs to be transmitted to a data writing component 1. The deinterleaving component 2 completes deinterleaving to obtain deinterleaved data 3 (of the odd data type) and deinterleaved data 4 (of the even data type), the deinterleaved data 3 needs to be transmitted to a data writing component 3, and the deinterleaved data 4 is not deinterleaved data required by a task request.

In the deinterleaving scheduler, the preferential scheduling identifier in the preferential scheduling register is 1, and the deinterleaving scheduler may determine the deinterleaving component 1 as the target deinterleaving component, and schedule the deinterleaved data 1 and the deinterleaved data 2 outputted by the target deinterleaving component.

The preferential storage type registered in the preferential storage register may be the odd data type, and the deinterleaving scheduler may determine the deinterleaved data 1 as the target deinterleaved data, and transmit the target deinterleaved data to the data writing component 1. Then, the preferential storage register may update the preferential storage type to the even data type, and the deinterleaving scheduler may determine the deinterleaved data 2 as the target deinterleaved data, and transmit the target deinterleaved data to the data writing component 1.

After the deinterleaving component 1 is scheduled, the preferential scheduling register may increase the preferential scheduling identifier by one, that is, the deinterleaving scheduler may determine the deinterleaving component 2 as the target deinterleaving component, schedule the deinterleaved data 3 outputted by the target deinterleaving component, determine the deinterleaved data 3 as the target deinterleaved data, and transmit the target deinterleaved data to the data writing component 3.

It can be seen that round-robin scheduling may be performed on the N deinterleaving components of the memory access engine (a DMA engine) by using the deinterleaving scheduler, and the deinterleaved data required by the task request is selected by using the deinterleaving scheduler, and is outputted to an associated arbitration component.

In some embodiments, the data bypass component and the deinterleaving component are integrated into one component, that is, the integrated deinterleaving component also performs bypass processing. Bypass processing (no processing is performed) may be performed on the to-be-migrated data by using the deinterleaving component, and then the to-be-migrated data is outputted by using the deinterleaving scheduler through round-robin scheduling.

The memory access engine may determine the deinterleaved data outputted by the deinterleaving component as the target migration data, and migrate the target migration data to the memory.

In some embodiments, if a target arbitration component receives the interleaved data and the target deinterleaved data, the target arbitration component determines both the interleaved data and the target deinterleaved data as to-be-arbitrated data (also referred to as “arbitration-candidate data”). Priority write selection is performed on the to-be-arbitrated data by using the target arbitration component, to obtain arbitrated data to be preferentially written, the arbitrated data to be preferentially written is determined as the target migration data, and the target migration data is transmitted to a target data writing component. The target data writing component is a data writing component connected to the target arbitration component.

In some embodiments, in the memory access engine, the arbitration component is connected to the deinterleaving scheduler and the interleaving component, uses the deinterleaved data (the target deinterleaved data) or the interleaved data as an input, and is connected to the corresponding data writing component. When the arbitration component simultaneously receives the interleaved data and the deinterleaved data, the memory access engine may determine the arbitration component as the target arbitration component, that is, the target arbitration component is an arbitration component receiving interleaved data and target deinterleaved data. When receiving only data outputted by the interleaving component or the deinterleaving scheduler, the arbitration component may perform bypass processing, and transmit the data to the data writing component connected to the arbitration component.

When simultaneously receiving data outputted by the interleaving component and the deinterleaving scheduler, the arbitration component may determine both the interleaved data and the deinterleaved data as the to-be-arbitrated data. Centralized arbitration may be selected. In centralized arbitration, arbitration requests for the interleaved data and the deinterleaved data are gathered, and the CPU performs priority write selection according to a task process, to determine the arbitrated data to be preferentially written, determines the arbitrated data to be preferentially written as the target migration data, and transmits the target migration data to the target data writing component.

Distribution arbitration may alternatively be selected. In distribution arbitration, an arbitration number of each task request is determined when the CPU assigns the task requests, and arbitration numbers corresponding to the interleaved data and the deinterleaved data are compared. To-be-arbitrated data (the interleaved data or the deinterleaved data) corresponding to an arbitration number with a higher priority is determined as the arbitrated data to be preferentially written, the arbitrated data to be preferentially written is determined as the target migration data, and the target migration data is transmitted to the target data writing component.

In some embodiments, the memory access engine migrates, by using the target data writing component, the target migration data (which may be the data outputted by the online processing component in operation S206, or the data outputted by the interleaving component in operation S207, or the data outputted by the deinterleaving component in operation S209) to the memory of the storage type corresponding to the target data writing component.

In some embodiments, the storage type refers to a storage type of a data writing component corresponding to to-be-migrated data in a task request. The data writing component may be a write interface that is in the memory access engine and that is configured to call a memory (which may be a local memory or an outer memory). The storage type is the same as that of the data reading component. The local memory and the outer memory may be specifically an L2 cache, a DDR RAM, or an L1 cache. The L1 cache may include an L1a cache and an L1b cache.

For example, a storage type of the data writing component 1 may correspond to an L2 cache, a storage type of the data writing component 2 may correspond to a DDR RAM, a storage type of the data writing component 3 may correspond to an L1a cache, and a storage type of a data writing component 4 may correspond to an L1b cache.

In the embodiments of this application, based on a task request (which may include a core service requirement, processing configuration information, an interleaving requirement, a deinterleaving requirement, and the like) assigned by the CPU, processing (which may be core service processing, online processing, interleaving, deinterleaving, bypass processing, or the like) that needs to be performed on the to-be-migrated data in the memory access engine is determined, the to-be-migrated data subjected to the processing corresponding to the task request is determined as the target migration data, and the target migration data is transmitted to the data writing component corresponding to the storage type, to complete data migration of the task request.

It can be seen that round-robin scheduling may be performed on the S core processing components integrated in the memory access engine (the DMA engine) by using the scheduler. Therefore, a core processing component does not need to be instantiated in each data path. In this way, core resources (the core processing components) between a plurality of data paths are multiplexed, and an effective area proportion of the memory access engine is improved.

In the embodiments of this application, data interaction (such as interleaving or deinterleaving) between the data read and write interfaces (the data reading components and the data writing components) of different storage types may be implemented by using the interleaving component and the deinterleaving component. In this way, subsequent calling of the CPU to complete data interaction is avoided, whereby resources of the CPU are saved, and a processing capability of the memory access engine for functions that requires data interaction, such as data encryption and Artificial Intelligence (AI) processing, is improved.

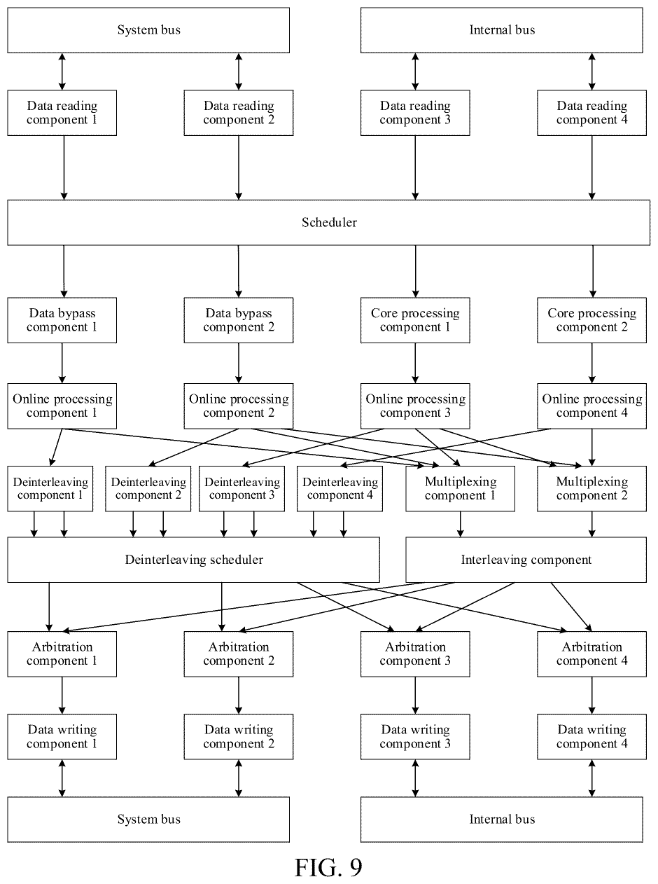

FIG. 9 is a third schematic structural diagram of a memory access engine according to an embodiment of this application. A data processing method may be performed by the memory access engine, and the memory access engine may be the memory access engine 102 of the terminal device 100 shown in FIG. 1.

The memory access engine includes: N data reading components, a scheduler, and S core processing components. Both N and S are positive integers greater than 1, and S is less than N. The N data reading components are respectively configured to read data of different storage types. The N data reading components are all connected to the scheduler, and the scheduler is respectively connected to the S core processing components.

The N data reading components are configured to obtain to-be-migrated data, and transmit the to-be-migrated data to the scheduler, the scheduler having a function of performing round-robin scheduling on a priority of a storage type.

The scheduler is configured to determine a storage type with a highest priority that is obtained through round-robin scheduling as a target storage type, and transmit target to-be-migrated data of the target storage type to a target core processing component in an idle state of the S core processing components.

The S core processing components are configured to process the target to-be-migrated data, to obtain processed data, the processed data being converted, in the memory access engine, into target migration data capable of being migrated to a memory.

As shown in FIG. 9 (N is 4, and S is 2), the N data reading components are respectively a data reading component 1, a data reading component 2, a data reading component 3, and a data reading component 4 in FIG. 9; and the S core processing components are respectively a core processing component 1 and a core processing component 2 in FIG. 9. Both the data reading component 1 and the data reading component 2 may be connected to a system bus (system storage), and both the data reading component 3 and the data reading component 4 may be connected to an internal bus (local storage). For a specific function of the data reading component, refer to the description of operation S101 in the embodiment corresponding to FIG. 3. All the data reading component 1, the data reading component 2, the data reading component 3, and the data reading component 4 in FIG. 9 may transmit the to-be-migrated data to the scheduler.

The scheduler includes S state registers and a priority register. The S state registers are respectively configured to register component states of different core processing components, and one state register is mapped to one core processing component. The priority register is configured to register a priority identifier.

The scheduler is further configured to obtain the priority identifier stored in the priority register, and determine a storage type mapped to the priority identifier as the target storage type; and

determine a state register, in which a component state is an idle state, of the S state registers as a target state register, determine a core processing component mapped to the target state register as the target core processing component, transmit the target to-be-migrated data of the target storage type to the target core processing component, and perform polling update on the priority identifier in the priority register, the priority identifier subjected to polling update being configured to represent that a next storage type after polling is the storage type with the highest priority.

For a component structure of the scheduler in FIG. 9, refer to the scheduler shown in FIG. 4. The S state registers of the scheduler in FIG. 9 may respectively be the state register 1 and the state register 2 in FIG. 4. The state register 1 may register a component state of the core processing component 1, and the state register 2 may register a component state of the core processing component 2. In FIG. 9, the core processing component 1 is connected to an online processing component 3 in series, and the core processing component 2 is connected to an online processing component 4 in series.

The scheduler is further configured to update the component state in the state register mapped to the target core processing component to a busy state when the target core processing component starts core service processing on the target to-be-migrated data; and re-update the component state in the state register mapped to the target core processing component to the idle state when the target core processing component completes the core service processing on the target to-be-migrated data.

The memory access engine further includes M data bypass components. Mis equal to a difference between N and S. The M data bypass components are all connected to the scheduler. The scheduler is further configured to detect a core service processing requirement for the target to-be-migrated data; and

transmit the target to-be-migrated data to the target core processing component of the S core processing components if the target to-be-migrated data requires core service processing; and transmit the target to-be-migrated data to the data bypass component if the target to-be-migrated data does not require core service processing, and determine target to-be-migrated data outputted by the data bypass component as the processed data.

As shown in FIG. 9 (M is 2), the M data bypass components are respectively a data bypass component 1 and a data bypass component 2 in FIG. 9. The data bypass component 1 is connected to an online processing component 1 in series, and the data bypass component 2 is connected to an online processing component 2 in series.

The memory access engine further includes N online processing components. The M data bypass components and the S core processing components are respectively connected to different online processing components. The M data bypass components are configured to transmit outputted processed data to the connected online processing components. The S core processing components are configured to transmit outputted processed data to the connected online processing components. The N online processing components are configured to convert the processed data into the target migration data capable of being migrated to the memory.

As shown in FIG. 9 (N is 4), the N online processing components are respectively the online processing component 1, the online processing component 2, the online processing component 3, and the online processing component 4 in FIG. 9. If core service processing needs to be performed on the to-be-migrated data (that is, a task request includes a core service requirement), the scheduler may determine the component state of the core processing component by using the state register, determine to-be-migrated data to be preferentially processed according to the priority identifier of the data reading component where the to-be-migrated data is located, and assign the target to-be-migrated data with the highest priority to the core service processing component in the idle state for core service processing. If core service processing does not need to be performed on the to-be-migrated data, the scheduler may perform bypass processing by using the bypass component, and transmit the to-be-migrated data to the online processing component.

The memory access engine may determine the to-be-migrated data subjected to bypass processing or core service processing as the processed data. For functions of the scheduler, the core processing component, and the data bypass component, refer to the description of operation S102 in the embodiment corresponding to FIG. 3.

The online processing component includes W scene processing components of different processing types and a multiplexer for each scene processing component. W is a positive integer. The W scene processing components are connected to each other in series. The online processing component is further configured to determine target processing configuration information corresponding to the processed data based on processing configuration information corresponding to the to-be-migrated data. The processing configuration information is set when a CPU assigns a migration request including the to-be-migrated data. The target processing configuration information includes K scene processing requirements, and K is a positive integer less than or equal to W. The online processing component is further configured to determine scene processing components, respectively corresponding to the K scene processing requirements, of the W scene processing components as target scene processing components, and perform scene processing associated with the K target scene processing components in sequence on the processed data based on a selection operation performed by the multiplexer on the K target scene processing components and the order of the K target scene processing components in the online processing component, to obtain the target migration data capable of being migrated to the memory.

For a component structure of the online processing component in FIG. 9, refer to the online processing component shown in FIG. 6 (W is 3). The W scene processing components of different processing types of the online processing component in FIG. 9 are respectively the ReLU component, the quantization component, and the bias adding component in FIG. 6. The online processing component in FIG. 9 may further include the multiplexer 6041, the multiplexer 6042, and the multiplexer 6043 in FIG. 6. For example, according to processing configuration information of processed data D, ReLU needs to be first performed on the processed data D and then bias adding is performed. Then, the K target scene processing components may be the ReLU component and the bias adding component.

In some embodiments, the online processing component may perform scene processing (which may include ReLU, quantization, bias adding, and the like) on the processed data according to the processing configuration information in a task request, to obtain scene processed data (which may be processed data subjected to scene processing required in the processing configuration information). For a function of the online processing component, refer to the description of operation S206 in the embodiment corresponding to FIG. 5.

In FIG. 9, the online processing component 1 is connected to a deinterleaving component 1, the online processing component 2 is connected to a deinterleaving component 2, the online processing component 3 is connected to a deinterleaving component 3, and the online processing component 4 is connected to a deinterleaving component 4. The online processing components (the online processing component 1, the online processing component 2, the online processing component 3, and the online processing component 4) may also respectively be connected to a multiplexing component 1, and the online processing components (the online processing component 1, the online processing component 2, the online processing component 3, and the online processing component 4) may also respectively be connected to a multiplexing component 2. That is, the multiplexing component 1 or the multiplexing component 2 may select required scene processed data from the online processing component 1, the online processing component 2, the online processing component 3, and the online processing component 4.

For the processed data on which bypass processing is performed by all the scene processing components based on the processing configuration information, after the foregoing processing is completed, the processed data may also be referred to as the scene processed data. The scene processed data is data outputted by the online processing component. The online processing component may transmit the scene processed data to the deinterleaving component or the multiplexing component according to the task request.

The memory access engine further includes Q multiplexing components and an interleaving component. Q is a positive even number less than N. There are at least two pieces of to-be-migrated data, and different pieces of to-be-migrated data respectively belong to different migration requests. The Q multiplexing components are configured to receive at least two pieces of processed data belonging to different migration requests, and the Q multiplexing components are connected to the interleaving component. The Q multiplexing components are configured to select C pieces of to-be-interleaved data from the at least two pieces of processed data, and transmit the C pieces of to-be-interleaved data to the interleaving component. C is a positive integer. The interleaving component is configured to interleave the C pieces of to-be-interleaved data, to obtain interleaved data. The interleaved data includes the C pieces of to-be-interleaved data staggered from each other; and the interleaved data is converted, in the memory access engine, into the target migration data capable of being migrated to the memory.

As shown in FIG. 9 (Q is 2), the Q multiplexing components are respectively the multiplexing component 1 and the multiplexing component 2 in FIG. 9. If the task request includes an interleaving requirement, the to-be-interleaved data may be selected by using the multiplexing component (the to-be-interleaved data is selected from the scene processed data or the processed data), and interleaved by using the interleaving component to obtain the interleaved data, and the interleaved data is transmitted to an arbitration component. For a function of the interleaving component, refer to the description of operation S207 in the embodiment corresponding to FIG. 5. The multiplexing component 1 is connected to the interleaving component, and the multiplexing component 2 is connected to the interleaving component. The interleaving component may be connected to an arbitration component 1, an arbitration component 2, an arbitration component 3, and an arbitration component 4, respectively. That is, the interleaving component may transmit the interleaved data to the associated arbitration component.

The memory access engine further includes N deinterleaving components and a deinterleaving scheduler. The N deinterleaving components are respectively configured to receive processed data of different storage types, and the deinterleaving scheduler is connected to the N deinterleaving components. The N deinterleaving components are configured to select to-be-deinterleaved data from the received processed data; and deinterleave the received to-be-deinterleaved data, to obtain at least two pieces of outputted deinterleaved data. The deinterleaving scheduler is configured to perform round-robin scheduling to obtain a preferential scheduling identifier with a highest priority, and determine a deinterleaving component corresponding to the preferential scheduling identifier with the highest priority as a target deinterleaving component; and perform round-robin scheduling on parity data types of at least two pieces of deinterleaved data outputted by the target deinterleaving component, determine a parity data type obtained through round-robin scheduling as a preferential storage type, determine deinterleaved data of the preferential storage type as target deinterleaved data, and output the target deinterleaved data. The target deinterleaved data is converted, in the memory access engine, into the target migration data capable of being migrated to the memory.

As shown in FIG. 9 (N is 4), the N deinterleaving components are respectively the deinterleaving component 1, the deinterleaving component 2, the deinterleaving component 3, and the deinterleaving component 4 in FIG. 9. If the task request includes a deinterleaving requirement, the scene processed data or the processed data may be deinterleaved by using the deinterleaving component to obtain the deinterleaved data, round-robin scheduling is performed on the deinterleaved data by using the deinterleaving scheduler, and the deinterleaved data is transmitted to the arbitration component. The deinterleaving component may also perform bypass processing, and the scene processed data subjected to bypass processing may also be referred to as the deinterleaved data. For a function of the deinterleaving component, refer to the description of operation S208 in the embodiment corresponding to FIG. 5. For a function of the deinterleaving scheduler, refer to the description of operation S209 in the embodiment corresponding to FIG. 5. The deinterleaving component 1, the deinterleaving component 2, the deinterleaving component 3, and the deinterleaving component 4 are respectively connected to the deinterleaving scheduler. The deinterleaving component may transmit the deinterleaved data to the deinterleaving scheduler. The deinterleaving scheduler may be connected to the arbitration component 1, the arbitration component 2, the arbitration component 3, and the arbitration component 4, respectively. That is, the deinterleaving component may transmit the deinterleaved data to the associated arbitration component.

The memory access engine further includes N arbitration components and N data writing components. The N data writing components are respectively configured to write data of different storage types. The deinterleaving scheduler is respectively connected to the N arbitration components, the interleaving component is respectively connected to the N arbitration components, and the N arbitration components are respectively connected to different data writing components. The N arbitration components include a target arbitration component, and the target arbitration component is an arbitration component that receives the interleaved data and the target deinterleaved data. The target arbitration component is configured to determine both the received interleaved data and the received target deinterleaved data as to-be-arbitrated data; perform priority write selection on the to-be-arbitrated data, to obtain arbitrated data to be preferentially written, determine the arbitrated data to be preferentially written as the target migration data, and transmit the target migration data to a target data writing component. The target data writing component is a data writing component connected to the target arbitration component; and the target data writing component is configured to migrate the target migration data to a memory of a storage type corresponding to the target data writing component.

As shown in FIG. 9 (Nis 4), the N arbitration components are respectively the arbitration component 1, the arbitration component 2, the arbitration component 3, and the arbitration component 4 in FIG. 9. The arbitration components (the arbitration component 1, the arbitration component 2, the arbitration component 3, and the arbitration component 4) may be connected to the deinterleaving scheduler and the interleaving component. That is, the arbitration components can not only receive the deinterleaved data transmitted by the deinterleaving scheduler, but also receive the interleaved data transmitted by the interleaving component. The arbitration component 1 is connected to a data writing component 1 in series, the arbitration component 2 is connected to a data writing component 2 in series, the arbitration component 3 is connected to a data writing component 3 in series, and the arbitration component 4 is connected to a data writing component 4 in series.

If the arbitration component receives only data (the deinterleaved data or the interleaved data) outputted by the interleaving component or the deinterleaving scheduler, the arbitration component may perform bypass processing, and transmit the data to the connected data writing component. If the arbitration component simultaneously receives data outputted by the interleaving component and the deinterleaving scheduler, the arbitration component may determine both the interleaved data and the deinterleaved data as the to-be-arbitrated data, and perform priority write selection on the to-be-arbitrated data, to determine the target migration data. For a function of the arbitration component, refer to the description of operation S209 in the embodiment corresponding to FIG. 5.

As shown in FIG. 9, the data writing components may include the data writing component 1, the data writing component 2, the data writing component 3, and the data writing component 4. The data writing component 1 and the data writing component 2 may be connected to the system bus, and the data writing component 3 and the data writing component 4 may be connected to the internal bus. The memory access engine may call a memory of a storage type corresponding to the data writing component by using the data writing component.

The memory access engine may migrate the target migration data to the memory of the storage type corresponding to the target data writing component by using the data writing component. For a function of the data writing component, refer to the description of operation S209 in the embodiment corresponding to FIG. 5.

For example, the task request assigned by the CPU includes:
1. transposing to-be-migrated data G0 in the data reading component 1 to obtain data G1, deinterleaving the data G1 to obtain data G2 (of an even data type) and data G3 (of an odd data type), and migrating the deinterleaved data G3 of the odd data type to the data writing component 4;
2. adding a bias to to-be-migrated data H0 in the data reading component 2 to obtain data H1, interleaving the data H1 and data I1 to obtain data J, and migrating the data J to the data writing component 4; and
3. adding a bias to to-be-migrated data I0 in the data reading component 3 to obtain the data I1, interleaving the data I1 and the data H1 to obtain the data J, and migrating the data J to the data writing component 4.

In some embodiments, the memory access engine obtains the to-be-migrated data G0, the to-be-migrated data H0, and the to-be-migrated data I0 by using the data reading components (the data reading component 1, the data reading component 2, and the data reading component 3).

The memory access engine may perform core service processing on the to-be-migrated data G0 by using the core processing component 1, to obtain the data G1, perform bypass processing on the data G1 by using the online processing component 3, transmit the data G1 to the deinterleaving component 3, deinterleave the data G1 by using the deinterleaving component 3 to obtain the data G2 (of the even data type) and the data G3 (of the odd data type), select the data G3 of the odd data type by using the deinterleaving scheduler, and transmit the data G3 to the arbitration component 4.

The memory access engine may perform bypass processing on the to-be-migrated data H0 by using the data bypass component 1, transmit the to-be-migrated data H0 to the online processing component 1, add a bias to the to-be-migrated data H0 by using the bias adding component in the online processing component 1, to obtain the data H1, select the data HI by using the multiplexing component 1, and transmit the data H1 to the interleaving component. The memory access engine may perform bypass processing on the to-be-migrated data 10 by using the data bypass component 2, transmit the to-be-migrated data I0 to the online processing component 2, add a bias to the to-be-migrated data 10 by using the bias adding component in the online processing component 2, to obtain the data I1, select the data I1 by using the multiplexing component 2, and transmit the data I1 to the interleaving component. The interleaving component may interleave the data Hl and the data I1, to obtain the data J, and the data J is transmitted to the arbitration component 4.

If the arbitration component 4 simultaneously receives the data G3 and the data J, centralized arbitration may be selected. The arbitration component 4 may gather arbitration requests for the data G3 and the data J, and the CPU performs priority write selection according to a task process. If the CPU selects the data G3 for write, the arbitration component 4 may transmit the data G3 to the data writing component 4, and after the data G3 is written into the memory, the arbitration component 4 transmits the data J to the data writing component 4, to complete the task request.

The entire structure shown in FIG. 9 may be a novel DMA chip. Round-robin scheduling may be performed on the S core processing components by using the scheduler integrated in the DMA chip (which may also be referred to as a memory access engine, or a DMA engine). Therefore, a core processing component does not need to be instantiated in each data path. In this way, core resources (the core processing components) between a plurality of data paths are multiplexed, and the novel DMA chip provided in this application has a smaller area. The DMA engine may be an independent chip on a motherboard, and may be used as a co-processor of the CPU. When data transmission is performed between memories of different storage types, the data transmission may be directly controlled by the DMA engine rather than the CPU. Therefore, the novel DMA engine provided in this application does not occupy excessive area of the motherboard, which can improve an effective area proportion of the motherboard.

In the embodiments of this application, data migration between any two of the memories of different storage types may be implemented by using read and write interfaces corresponding to the memories of different storage types, namely, the data reading components and the data writing components. The target to-be-migrated data is processed by using the target core processing component, to obtain processed data. The processed data is converted, in the memory access engine, into the target migration data capable of being migrated to the memory. It can be seen that round-robin scheduling may be performed on the S core processing components integrated in the memory access engine (the DMA engine) by using the scheduler. Therefore, a core processing component does not need to be instantiated in each data path. In this way, core resources (the core processing components) between a plurality of data paths are multiplexed, and an effective area proportion of the memory access engine is improved.

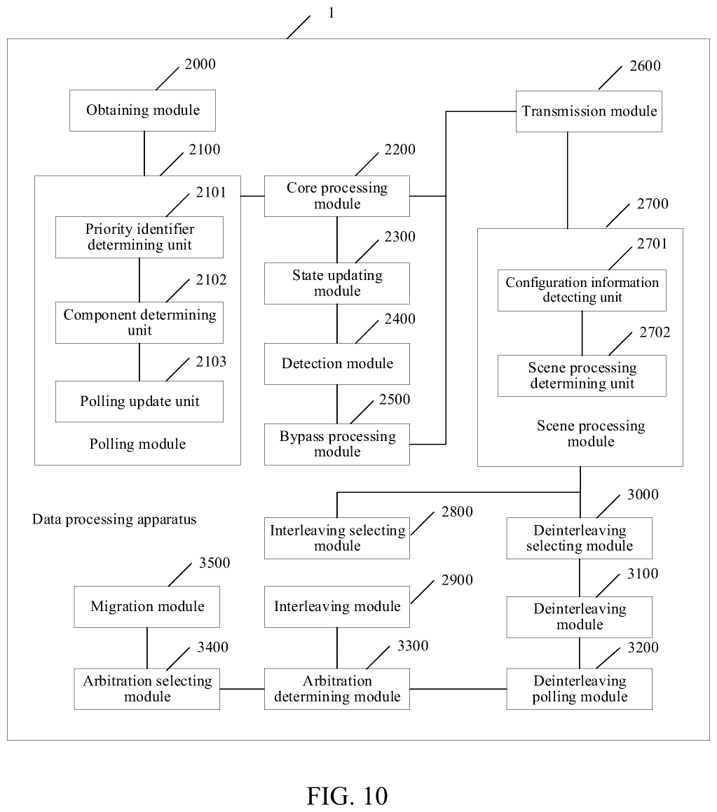

FIG. 10 is a schematic structural diagram of a data processing apparatus according to an embodiment of this application. As shown in FIG. 10, a data processing apparatus 1 includes an obtaining module 2000, a polling module 2100, a core processing module 2200, a state updating module 2300, a detection module 2400, a bypass processing module 2500, a transmission module 2600, a scene processing module 2700, an interleaving selecting module 2800, an interleaving module 2900, a deinterleaving selecting module 3000, a deinterleaving module 3100, a deinterleaving polling module 3200, an arbitration determining module 3300, an arbitration selecting module 3400, and a migration module 3500. The polling module 2100 includes a priority identifier determining unit 2101, a component determining unit 2102, and a polling update unit 2103. The scene processing module 2700 includes a configuration information detecting unit 2701 and a scene processing determining unit 2702.

The obtaining module 2000 is configured to obtain to-be-migrated data by using N data reading components, and transmit the to-be-migrated data to a scheduler, the scheduler having a function of performing round-robin scheduling on a priority of a storage type. For an implementation of the function of the obtaining module 2000, refer to the description of operation S101 in the embodiment corresponding to FIG. 3.

The polling module 2100 is configured to determine a storage type with a highest priority that is obtained by the scheduler through round-robin scheduling as a target storage type, and transmit target to-be-migrated data of the target storage type by using the scheduler to a target core processing component of S core processing components, the target core processing component being a core processing component in an idle state. For an implementation of the function of the polling module 2100, refer to the description of operation S102 in the embodiment corresponding to FIG. 3.

The priority identifier determining unit 2101 is configured to process the target to-be-migrated data by using the target core processing component, to obtain processed data, the processed data being converted, in a memory access engine, into target migration data capable of being migrated to a memory.

The component determining unit 2102 is configured to determine a state register, in which a component state is the idle state, of S state registers as a target state register, and determine a core processing component mapped to the target state register as the target core processing component.

The polling update unit 2103 is configured to transmit the target to-be-migrated data to the target core processing component, and perform polling update on a priority identifier in a priority register, the priority identifier subjected to polling update being configured to represent that a next storage type after polling is the storage type with the highest priority.

The core processing module 2200 is configured to process the target to-be-migrated data by using the target core processing component, to obtain processed data, the processed data being converted, in the memory access engine, into the target migration data capable of being migrated to the memory. The core processing module 2200 is further configured to perform the operation of transmitting target to-be-migrated data by using the scheduler to a target core processing component of S core processing components if there is a core service processing requirement for the target to-be-migrated data. For an implementation of the function of the core processing module 2200, refer to the description of operation S102 in the embodiment corresponding to FIG. 3.

The state updating module 2300 is configured to update the component state in the state register mapped to the target core processing component to a busy state when the target core processing component starts core service processing on the target to-be-migrated data; and re-update the component state in the state register mapped to the target core processing component to the idle state when the target core processing component completes the core service processing on the target to-be-migrated data.

The detection module 2400 is configured to detect the core service processing requirement for the target to-be-migrated data. The bypass processing module 2500 is configured to transmit the target to-be-migrated data by using the scheduler to a data bypass component if there is no core service processing requirement for the target to-be-migrated data, and determine target to-be-migrated data outputted by the data bypass component as the processed data.

The transmission module 2600 is configured to transmit the processed data outputted by the data bypass component or the target core processing component to a connected online processing component. For an implementation of the function of the transmission module 2600, refer to the description of operation S204 in the embodiment corresponding to FIG. 5.

The scene processing module 2700 is configured to convert, by using the online processing component, the processed data into the target migration data capable of being migrated to the memory.

The configuration information detecting unit 2701 is configured to determine target processing configuration information corresponding to the processed data based on processing configuration information corresponding to the to-be-migrated data, the processing configuration information being set when a CPU assigns a migration request including the to-be-migrated data; and the target processing configuration information including K scene processing requirements, and K being a positive integer less than or equal to W. For an implementation of the function of the configuration information detecting unit 2701, refer to the description of operation S205 in the embodiment corresponding to FIG. 5.

The scene processing determining unit 2702 is configured to determine scene processing components, respectively corresponding to the K scene processing requirements, of W scene processing components as target scene processing components, and perform scene processing associated with the K target scene processing components in sequence on the processed data based on a selection operation performed by a multiplexer on the K target scene processing components and the order of the K target scene processing components in the online processing component, to obtain the target migration data capable of being migrated to the memory. For an implementation of the function of the scene processing determining unit 2702, refer to the description of operation S206 in the embodiment corresponding to FIG. 5.

The interleaving selecting module 2800 is configured to select C pieces of to-be-interleaved data from at least two pieces of processed data by using Q multiplexing components, and transmit the C pieces of to-be-interleaved data to an interleaving component, C being a positive integer. The interleaving module 2900 is configured to interleave the C pieces of to-be-interleaved data by using the interleaving component, to obtain interleaved data, the interleaved data including the C pieces of to-be-interleaved data staggered from each other; and the interleaved data being converted, in the memory access engine, into the target migration data capable of being migrated to the memory.

For specific implementations of the functions of the interleaving selecting module 2800 and the interleaving module 2900, refer to the description of operation S207 in the embodiment corresponding to FIG. 5.

The deinterleaving selecting module 3000 is configured to select to-be-deinterleaved data from received processed data by using N deinterleaving components. The deinterleaving module 3100 is configured to deinterleave received to-be-deinterleaved data by using each deinterleaving component, to obtain at least two pieces of deinterleaved data respectively outputted by each deinterleaving component.

For implementations of the functions of the deinterleaving selecting module 3000 and the deinterleaving module 3100, refer to the description of operation S208 in the embodiment corresponding to FIG. 5.

The deinterleaving polling module 3200 is configured to obtain a preferential scheduling identifier with a highest priority by using a deinterleaving scheduler through round-robin scheduling, and determine a deinterleaving component corresponding to the preferential scheduling identifier with the highest priority as a target deinterleaving component; and perform, by using the deinterleaving scheduler, round-robin scheduling on parity data types of at least two pieces of deinterleaved data outputted by the target deinterleaving component, determine a parity data type obtained by the deinterleaving scheduler through round-robin scheduling as a preferential storage type, determine deinterleaved data of the preferential storage type as target deinterleaved data, and output the target deinterleaved data by using the deinterleaving scheduler, the target deinterleaved data being converted, in the memory access engine, into the target migration data capable of being migrated to the memory.

For a specific implementation of the function of the deinterleaving polling module 3200, refer to the description of operation S209 in the embodiment corresponding to FIG. 5.

The arbitration determining module 3300 is configured to determine both the interleaved data and the target deinterleaved data as to-be-arbitrated data if a target arbitration component receives the interleaved data and the target deinterleaved data. The arbitration selecting module 3400 is configured to perform priority write selection on the to-be-arbitrated data by using the target arbitration component, to obtain arbitrated data to be preferentially written, determine the arbitrated data to be preferentially written as the target migration data, and transmit the target migration data to a target data writing component, the target data writing component being a data writing component connected to the target arbitration component.

For implementations of the functions of the arbitration determining module 3300 and the arbitration selecting module 3400, refer to the description of operation S209 in the embodiment corresponding to FIG. 5.

The migration module 3500 is configured to migrate the target migration data to a memory of a storage type corresponding to the target data writing component by using the target data writing component. For an implementation of the function of the migration module 3500, refer to the description of operation S209 in the embodiment corresponding to FIG. 5.

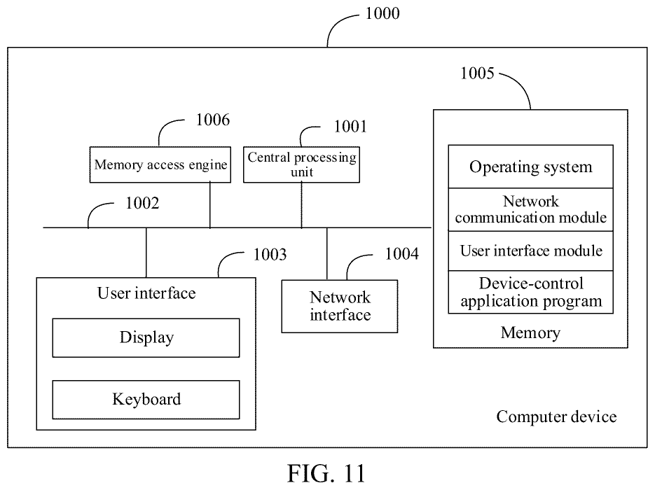

FIG. 11 is a schematic structural diagram of a computer device according to an embodiment of this application. As shown in FIG. 11, a computer device 1000 may include: a CPU 1001, a network interface 1004, a memory 1005, and a memory access engine 1006. In addition, the foregoing computer device 1000 may include: a user interface 1003 and at least one communication bus 1002. The communication bus 1002 is configured to implement connection and communication between these components. The user interface 1003 may include a display and a keyboard. The user interface 1003 may further include a standard wired interface and a standard wireless interface. The network interface 1004 may include a standard wired interface and a standard wireless interface (such as a Wi-Fi interface). The memory 1005 may be a high-speed RAM, or may be a non-volatile memory, for example, at least one magnetic disk memory. The memory 1005 may further be at least one storage apparatus that is located far away from the CPU 1001. As shown in FIG. 11, the memory 1005 used as a computer-readable storage medium may include an operating system, a network communication module, a user interface module, and a device-control application program. The memory access engine 1006 may include several data reading components, several core processing components, and a scheduler. The memory access engine may obtain to-be-migrated data from the memory 1005 by using the data reading components, transmit the to-be-migrated data to the scheduler, perform round-robin scheduling on the core processing components by using the scheduler, to multiplex the core processing components between a plurality of data paths, determine the to-be-migrated data subjected to core service processing as target migration data, and transmit the target migration data to a memory 1005 of another storage type.

In the computer device 1000 shown in FIG. 11, the network interface 1004 may provide a network communication function. The user interface 1003 is mainly configured to provide an input interface for a user. The memory access engine 1006 may invoke the device-control application program stored in the memory 1005 according to a task request of the CPU 1001 to implement:

obtaining the to-be-migrated data by using the N data reading components, and transmitting the to-be-migrated data to the scheduler, the scheduler having the function of performing round-robin scheduling on a priority of a storage type; determining a storage type with a highest priority that is obtained by the scheduler through round-robin scheduling as a target storage type, and transmitting target to-be-migrated data of the target storage type by using the scheduler to a target core processing component in an idle state of S core processing components; and processing the target to-be-migrated data by using the target core processing component, to obtain processed data, the processed data being converted, in the memory access engine, into target migration data capable of being migrated to a memory.

The computer device 1000 described in the embodiments of this application may perform the data processing method described in any one of the embodiments corresponding to FIG. 3 and FIG. 5. For beneficial effects achieved by the computer device, refer to the beneficial effects achieved by the data processing method.

In addition, the embodiments of this application provide a computer-readable storage medium, which has a computer program stored therein. The foregoing memory access engine, when executing the foregoing computer program, can perform the foregoing data processing method described in any one of the embodiments corresponding to FIG. 3 and FIG. 5, to achieve the same beneficial effects as the data processing method. For technical details that are not disclosed in the computer-readable storage medium embodiments of this application, refer to the descriptions of the method embodiments of this application.

The computer-readable storage medium may be an internal storage unit of the data processing apparatus provided in any one of the foregoing embodiments or the foregoing computer device, for example, a hard disk or an internal memory of the computer device. The computer-readable storage medium may alternatively be an external storage device of the computer device, for example, a plug-in hard disk, a smart media card (SMC), a secure digital (SD) card, or a flash card that is equipped in the computer device. Further, the computer-readable storage medium may include both an internal storage unit and an external storage device of the computer device. The computer-readable storage medium is configured to store the computer program and other programs and data required by the computer device. The computer-readable storage medium may further be configured to temporarily store displayed or to-be-displayed data.

In addition, the embodiments of this application further provide a computer program product, which includes a computer program. The computer program is stored in a computer-readable storage medium. A memory access engine of a computer device reads the computer program from the computer-readable storage medium, and executes the computer program, to cause the computer device to perform the method provided in any one of the embodiments corresponding to FIG. 3 and FIG. 5.

The terms “first”, “second”, and the like in the description of the embodiments, the claims, and the accompanying drawings of this application are used for distinguishing between different objects, and are not used for describing a specific sequence. In addition, the term “include” and any variant thereof are intended to cover a non-exclusive inclusion. For example, a process, method, apparatus, product, or device that includes a series of operations or units is not limited to the listed operations or modules; and instead, in some embodiments, further includes an operation or module that is not listed, or in some embodiments, further includes another operation or unit that is intrinsic to the process, method, apparatus, product, or device.

Those of ordinary skill in the art may be aware that, with reference to the examples described in the embodiments of this specification, units and algorithm operations may be implemented in the form of electronic hardware, computer software, or a combination thereof. To clearly describe the interchangeability between the hardware and the software, the foregoing has generally described compositions and operations of each example according to functions. Whether the functions are executed in the form of hardware or software depends on particular applications and design constraint conditions of the technical solutions. Those skilled in the art may use different methods to implement the described functions for each particular application, but these implementations are not considered to be beyond the scope of this application.

What is disclosed above is merely exemplary embodiments of this application, and certainly is not intended to limit the scope of the claims of this application. Therefore, equivalent variations made in accordance with the claims of this application fall within the scope of this application.

What is claimed is:

1. A data processing method comprising:
obtaining migration-candidate data using N data reading components of a memory access engine, and transmitting the migration-candidate data to a scheduler of the memory access engine, N being a positive integer greater than 1;
determining a target storage type and transmitting, using the scheduler, target migration-candidate data to a target core processing component, the target migration-candidate data being at least a portion of the migration-candidate data that has the target storage type, the target storage type being a storage type with a highest priority determined by the scheduler through round-robin scheduling, the target core processing component being one of S core processing components, that is in an idle state, of the memory access engine, and S being a positive integer greater than 1 but less than N; and
processing the target migration-candidate data using the target core processing component, to obtain processed data to be converted in the memory access engine into target migration data capable of being migrated to a memory.

2. The method according to claim 1, wherein:
the scheduler includes:
a priority register; and
S state registers mapped to and configured to register component states of the S core processing components, respectively; and
determining the target storage type and transmitting the target migration-candidate data to the target core processing component includes:
obtaining a priority identifier stored in the priority register, and determining a storage type mapped to the priority identifier as the target storage type;
determining a state register, in which a component state is the idle state, of the S state registers as a target state register, and determining a core processing component mapped to the target state register as the target core processing component; and
transmitting the target migration-candidate data to the target core processing component, and performing polling update on the priority identifier in the priority register, the priority identifier subjected to polling update representing that a next storage type after polling is the storage type with the highest priority.

3. The method according to claim 2, further comprising:
updating the component state in the target state register to a busy state in response to the target core processing component starting processing on the target migration-candidate data; and
updating the component state in the target state register to the idle state in response to the target core processing component completing the processing on the target migration-candidate data.

4. The method according to claim 1, further comprising:
performing the operation of transmitting the target migration-candidate data to the target core processing component in response to the target migration-candidate data requiring core service processing; and
transmitting the target migration-candidate data using the scheduler to one data bypass component of M data bypass components of the memory access engine in response to the target migration-candidate data not requiring core service processing and determining the target migration-candidate data outputted by the one data bypass component as the processed data, M equaling a difference between N and S.

5. The method according to claim 4, further comprising:
transmitting the processed data outputted by the one data bypass component or the target core processing component to one online processing component, connected to the one data bypass component or the target core processing component, of N online processing components of the memory access engine; and
converting, using the one online processing component, the processed data into the target migration data.

6. The method according to claim 5, wherein:
the one online processing component includes:
W scene processing components of different processing types and connected to each other in series, W being a positive integer; and
W multiplexers each corresponding to one of the W scene processing components; and
converting the processed data into the target migration data includes:
determining target processing configuration information corresponding to the processed data according to processing configuration information corresponding to the migration-candidate data, the processing configuration information being set when a central processing unit (CPU) assigns a migration request including the migration-candidate data, and the target processing configuration information includes K scene processing requirements, K being a positive integer less than or equal to W; and
determining, from the W scene processing components, K target scene processing components that respectively correspond to the K scene processing requirements, and performing scene processing associated with the K target scene processing components in sequence on the processed data based on a selection operation, performed by each of K multiplexers corresponding to the K target scene processing components on a corresponding one of the K target scene processing components, and an order of the K target scene processing components in the one online processing component, to obtain the target migration data.

7. The method according to claim 1,
wherein:
the migration-candidate data includes at least two pieces of migration-candidate data belonging to at least two migration requests, respectively, and the processed data includes at least two pieces of processed data belonging to the at least two migration requests, respectively; and
the memory access engine further includes:
an interleaving component; and
Q multiplexing components connected to the interleaving component and configured to receive the at least two pieces of processed data, Q being a positive even number less than N;
the method further comprising:
selecting C pieces of interleaving-candidate data from the at least two pieces of processed data using the Q multiplexing components, and transmitting the C pieces of interleaving-candidate data to the interleaving component, C being a positive integer; and
interleaving the C pieces of interleaving-candidate data using the interleaving component, to obtain interleaved data to be converted, in the memory access engine, into the target migration data, the interleaved data including the C pieces of interleaving-candidate data that are staggered from each other.

8. The method according to claim 7,
wherein the memory access engine further includes:
a deinterleaving scheduler; and
N deinterleaving components connected to the deinterleaving scheduler, the N deinterleaving components being respectively configured to receive processed data of different storage types;
the method further comprising:
selecting deinterleaving-candidate data from received processed data using the N deinterleaving components;
deinterleaving the received deinterleaving-candidate data using each of the N deinterleaving components, to obtain at least two pieces of deinterleaved data outputted by each of the N deinterleaving components;
obtaining a preferential scheduling identifier with a highest priority using the deinterleaving scheduler through round-robin scheduling, and determining one of the N deinterleaving components corresponding to the preferential scheduling identifier with the highest priority as a target deinterleaving component; and
performing, using the deinterleaving scheduler, round-robin scheduling on parity data types of at least two pieces of deinterleaved data outputted by the target deinterleaving component, determining a parity data type obtained by the deinterleaving scheduler through round-robin scheduling as a preferential storage type, determining deinterleaved data of the preferential storage type as target deinterleaved data, and outputting the target deinterleaved data using the deinterleaving scheduler for being converted, in the memory access engine, into the target migration data.

9. The method according to claim 8,
wherein:
the memory access engine further includes:
N arbitration components connected to the deinterleaving scheduler and the interleaving component, and including a target arbitration component that receives the interleaved data and the target deinterleaved data; and
N data writing components connected to the N arbitration components, respectively, and being configured to write data of different storage types, respectively, the N data writing components including a target data writing component connected to the target arbitration component;
the method further comprising:
determining the interleaved data and the target deinterleaved data that are received by the target arbitration component as arbitration-candidate data;
performing priority write selection on the arbitration-candidate data using the target arbitration component, to obtain arbitration data to be preferentially written as the target migration data, and transmitting the target migration data to the target data writing component; and
migrating the target migration data using the target data writing component to a memory of a storage type corresponding to the target data writing component.

10. A non-transitory computer-readable storage medium storing a computer program that, when executed by a memory access engine, causes a computer device including the memory access engine to perform the method according to claim 1.

11. A memory access engine comprising:
N data reading components, a scheduler connected to the N data reading components, and S core processing components connected to the scheduler, N and S being positive integers greater than 1, and S being less than N;
wherein:
the N data reading components are configured to obtain migration-candidate data, and transmit the migration-candidate data to the scheduler;
the scheduler is configured to determine a storage type with a highest priority that is obtained through round-robin scheduling as a target storage type, and transmit target migration-candidate data to a target core processing component, the target migration-candidate data being at least a portion of the migration-candidate data that has the target storage type, and the target core processing component being one of the S core processing components that is in an idle state; and
the target core processing component is configured to process the target migration-candidate data to obtain processed data to be converted in the memory access engine into target migration data capable of being migrated to a memory.

12. The memory access engine according to claim 11, wherein:
the scheduler includes:
a priority register; and
S state registers mapped to and configured to register component states of the S core processing components, respectively; and
the scheduler is further configured to:
obtain a priority identifier stored in the priority register, and determining a storage type mapped to the priority identifier as the target storage type;
determine a state register, in which a component state is the idle state, of the S state registers as a target state register, and determining a core processing component mapped to the target state register as the target core processing component; and
transmit the target migration-candidate data to the target core processing component, and performing polling update on the priority identifier in the priority register, the priority identifier subjected to polling update representing that a next storage type after polling is the storage type with the highest priority.

13. The memory access engine according to claim 12, wherein the scheduler is further configured to:
update the component state in the target state register to a busy state in response to the target core processing component starting processing on the target migration-candidate data; and
update the component state in the target state register to the idle state in response to the target core processing component completing the processing on the target migration-candidate data.

14. The memory access engine according to claim 11, further comprising:
M data bypass components connected to the scheduler, M being equal to a difference between N and S;
wherein the scheduler is further configured to:
transmit the target migration-candidate data to the target core processing component in response to the target migration-candidate data requiring core service processing; and
transmit the target migration-candidate data to one data bypass component of the M data bypass components in response to the target migration-candidate data not requiring core service processing and determine the target migration-candidate data outputted by the one data bypass component as the processed data.

15. The memory access engine according to claim 14, further comprising:
N online processing components, the M data bypass components and the S core processing components being respectively connected to different ones of the N online processing components;
wherein:
each of the M data bypass components is configured to transmit outputted processed data to one of the N online processing components that is connected to the data bypass component;
each of the S core processing components is configured to transmit outputted processed data to one of the N online processing components that is connected to the core processing component; and
each of the N online processing components is configured to convert the processed data into the target migration data.

16. The memory access engine according to claim 15, wherein:
one online processing component of the N online processing components includes:
W scene processing components of different processing types and connected to each other in series, W being a positive integer; and
W multiplexers each corresponding to one of the W scene processing components; and
the one online processing component is further configured to:
determine target processing configuration information corresponding to the processed data according to processing configuration information corresponding to the migration-candidate data, the processing configuration information being set when a central processing unit (CPU) assigns a migration request including the migration-candidate data, and the target processing configuration information includes K scene processing requirements, K being a positive integer less than or equal to W; and
determine, from the W scene processing components, K target scene processing components that respectively correspond to the K scene processing requirements, and performing scene processing associated with the K target scene processing components in sequence on the processed data based on a selection operation, performed by each of K multiplexers corresponding to the K target scene processing components on a corresponding one of the K target scene processing components, and an order of the K target scene processing components in the one online processing component, to obtain the target migration data.

17. The memory access engine according to claim 11, further comprising:
an interleaving component; and
Q multiplexing components connected to the interleaving component, Q being a positive even number less than N;
wherein:
the migration-candidate data includes at least two pieces of migration-candidate data belonging to at least two migration requests, respectively, and the processed data includes at least two pieces of processed data belonging to the at least two migration requests, respectively;
the Q multiplexing components are configured to:
receive the at least two pieces of processed data; and
select C pieces of interleaving-candidate data from the at least two pieces of processed data using the Q multiplexing components, and transmitting the C pieces of interleaving-candidate data to the interleaving component, C being a positive integer; and
the interleaving component is configured to interleave the C pieces of interleaving-candidate data using the interleaving component, to obtain interleaved data to be converted, in the memory access engine, into the target migration data, the interleaved data including the C pieces of interleaving-candidate data that are staggered from each other.

18. The memory access engine according to claim 17, further comprising:
a deinterleaving scheduler; and
N deinterleaving components connected to the deinterleaving scheduler, the N deinterleaving components being respectively configured to receive processed data of different storage types;
wherein:
the N deinterleaving components are configured to:
select deinterleaving-candidate data from received processed data;
deinterleave the received deinterleaving-candidate data, to obtain at least two pieces of deinterleaved data outputted; and
the deinterleaving scheduler is configured to:
obtain a preferential scheduling identifier with a highest priority through round-robin scheduling, and determine one of the N deinterleaving components corresponding to the preferential scheduling identifier with the highest priority as a target deinterleaving component; and
perform round-robin scheduling on parity data types of at least two pieces of deinterleaved data outputted by the target deinterleaving component, determine a parity data type obtained through round-robin scheduling as a preferential storage type, determine deinterleaved data of the preferential storage type as target deinterleaved data, and output the target deinterleaved data for being converted, in the memory access engine, into the target migration data.

19. The memory access engine according to claim 18, further comprising:
N arbitration components connected to the deinterleaving scheduler and the interleaving component, and including a target arbitration component that receives the interleaved data and the target deinterleaved data; and
N data writing components connected to the N arbitration components, respectively, and being configured to write data of different storage types, respectively, the N data writing components including a target data writing component connected to the target arbitration component;
wherein the target arbitration component is configured to:
determine the interleaved data and the target deinterleaved data that are received by the target arbitration component as arbitration-candidate data;
perform priority write selection on the arbitration-candidate data to obtain arbitration data to be preferentially written as the target migration data; and
transmit the target migration data to the target data writing component.

20. A computer device comprising:
a memory storing a computer program;
a network interface; and
a memory access engine connected to the memory and the network interface, and configured to invoke the computer program, to cause the computer device to:
obtain migration-candidate data using N data reading components of the memory access engine, and transmit the migration-candidate data to a scheduler of the memory access engine, N being a positive integer greater than 1;
determine a target storage type and transmit, using the scheduler, target migration-candidate data to a target core processing component, the target migration-candidate data being at least a portion of the migration-candidate data that has the target storage type, the target storage type being a storage type with a highest priority determined by the scheduler through round-robin scheduling, the target core processing component being one of S core processing components, that is in an idle state, of the memory access engine, and S being a positive integer greater than 1 but less than N; and
process the target migration-candidate data using the target core processing component, to obtain processed data to be converted in the memory access engine into target migration data capable of being migrated to a memory.
